(19) United States
(12) Patent Application Publication
(10) Pub. No.: US 2026/0171710 A1
(43) Pub. Date: Jun. 18, 2026

(54) CONNECTOR ASSEMBLY AND CONNECTOR SYSTEM

(71) Applicant: Molex, LLC, Lisle, IL (US)

(72) Inventors: Dao-Jie Ju, Chengdu City (CN); Bai Hu, Chengdu City (CN); Gang Luo, Chengdu City (CN)

(21) Appl. No.: 19/409,198

(22) Filed: Dec. 4, 2025

(30) Foreign Application Priority Data
Dec. 12, 2024 (CN) 202411833068.8

(51) Int. Cl. H01R 13/514

(52) U.S. Cl. CPC H01R 13/514

(57) ABSTRACT

A first connector assembly includes a main outer housing, at least two different types of first terminal modules, and at least one independent secondary locking member. The main outer housing has at least two receiving cavities, each extending along an up-down direction, and each capable of allowing any type of first terminal module to be interchangeably inserted therein. Each first terminal module includes a first module housing and multiple first conductive terminals mounted therein. The first module housing has at least one locking structure which is capable of cooperating with a locking structure of the receiving cavity to lock the first module housing to the main outer housing. The independent secondary locking member passes through the main outer housing into the receiving cavities, so that the first terminal modules are locked to the main outer housing.

### TECHNICAL FIELD

The present disclosure relates to technical field of electrical connectors, and particularly relates to a first connector assembly and a connector system.

### BACKGROUND

With rapid development of relevant fields, high requirement is proposed on flexible design and application of electrical connectors. For example, an existing modularized mating connector (application No: DE202023103558U1) includes a housing and mating modules, the housing has grooves, the mating module are arranged in the grooves respectively, the mating module is used to receive multiple mating elements in a manner that the multiple mating elements are prevented from being lost. However, in the above existing solution, because the mating module of the modularized mating connector is provided with a mechanical key mechanism, the mating module cannot realize to make the grooves interchanged, cannot meet apply requirement of flexible manufacturing situation, when the user employs a different mating module or change a position of the mating module, the housing needs to be changed, universality is poor to result in high manufacturing cost.

### SUMMARY

One main object of the present disclosure is to provide a first connector assembly which has flexibility in manufacturing and can lower manufacturing cost in order to overcome at least one deficiency of the above prior art.

In order to attain the above object, the present disclosure employs the following technical solutions.

According to one aspect of the present disclosure, the present disclosure provides a first connector assembly comprising a main outer housing, at least two different types of first terminal modules provided in the main outer housing, and at least one independent secondary locking member; the main outer housing being provided therein with at least two receiving cavities, each receiving cavity extends along an up-down direction, and the at least two receiving cavities are capable of allowing any type of first terminal module to be interchangeable to insert therein; an inner wall of each receiving cavity of the main outer housing is provided thereon with at least one first locking structure, each first terminal module comprises a first module housing and multiple first conductive terminals mounted in the first module housing, an outer wall of the first module housing is provided thereon with at least one second locking structure, the second locking structure is capable of cooperating with the first locking structure to lock the first module housing to the main outer housing; a wall of the main outer housing is provided with through holes, the independent secondary locking member partially passes through the through holes to insert into the receiving cavities, so that the first terminal modules are locked to the main outer housing.

According to one of embodiments, the first locking structure is an elastic latching arms which extends along the up-down direction, the second locking structure comprises a latching hook which protrudes outwardly from the first module housing, an upper side and a lower side of the latching hook are respectively provided with a first guiding surface and a first latching surface.

According to one of embodiments, the wall of the main outer housing is further provided with openings, one end of the elastic latching arm is integrally connected to one side of the opening; a tip of the elastic latching arm is provided with a second guiding surface and a second latching surface; when the main outer housing and the first terminal module are assembled along the up-down direction, the first guiding surface of the latching hook slides over the second guiding surface of the elastic latching arm, and then the first latching surface of the latching hook abuts against the second latching surface of the elastic latching arm, so that the first terminal module is locked to the main outer housing.

According to one of embodiments, the independent secondary locking member comprises a latching board and latching arms connected to a side of the latching board, the latching board is provided to an outer side of the main outer housing and latches with the main outer housing, the latching arm passes through the through hole to insert into the receiving cavity, the latching arm is provided with multiple latching protrusions, the outer wall of the first module housing is provided thereon with a latching hole, the latching arm correspondingly inserts into the latching hole to lock the multiple first conductive terminals.

According to one of embodiments, the first locking structure and the independent secondary locking member are respectively positioned to different sides of the main outer housing, the latching arm of the independent secondary locking member extends to an inner side of the second locking structure, so as to prevent cooperation between the first locking structure and the second locking structure from being released.

According to one of embodiments, a cross section of the first module housing is a rectangle, and two adjacent edges of the rectangle define a first direction and a second direction; the latching board is correspondingly mounted to a side of the main outer housing along the first direction, the latching arms extend along the first direction, the latching hole is provided to the outer wall of the first module housing perpendicular to the first direction.

According to one of embodiments, the first connector assembly comprises two independent secondary locking members, the two independent secondary locking members are respectively provided to two opposite sides of the main outer housing in the first direction, each independent secondary locking member further comprises two jaws which bend from two side edges of the latching board and extend along the same direction as the latching arms, the main outer housing is provided thereon with latching steps, the two jaws are capable of engaging with the latching steps, so that the independent secondary locking member is retained in a pre-locking state or a locking state.

According to one of embodiments, the first terminal modules are arranged as two groups which are arranged along the first direction, each group comprises at least two first terminal modules which are arranged along the second direction; the two independent secondary locking members respectively latch with the two groups of first terminal modules, the latching board is provided with at least two latching arms, the at least two latching arms respectively latch with the at least two first terminal modules of the same group.

According to one of embodiments, the first connector assembly further comprises a terminal stabilizer, the terminal stabilizer is provided in the main outer housing, and latches with the main outer housing in a manner that the terminal stabilizer could be movable up and down; the terminal stabilizer is provided with several holes which allow the first conductive terminals to correspondingly pass therethrough.

According to one of embodiments, side edges of the terminal stabilizer are provided with first latching structures, the first latching structures are hooks which extend upwardly from two sides of the terminal stabilizer, a side surface of the terminal stabilizer which faces the first terminal modules is provided with third latching structures, the inner walls of the receiving cavities are provided with fourth latching structures, the third latching structure and the fourth latching structure cooperate with each other to limit the highest position that the terminal stabilizer slides upwardly.

According to one of embodiments, the third latching structure comprises two latch arms which are provided with a gap therebetween, two opposite sides of the two latch arms are respectively provided with a third guiding surface which extends gradually, outwardly and obliquely from up to down and a third latching surface which extends horizontally, the fourth latching structure comprises a latching groove, two side groove walls of the latching groove which face each other are respectively provided with a fourth guiding surface which extends gradually, outwardly and obliquely from up to down and a fourth latching surface which extends horizontally; wherein the third latching surface and the fourth latching surface abut against each other to prevent the terminal stabilizer from being upwardly removed from the main outer housing.

According to one of embodiments, dimensions and shapes of openings of the at least two receiving cavities are substantially consistent; dimensions and shapes of outer contours of the at least two first module housings also are substantially consistent, but cavities in an interior of the at least two first module housings which are used to correspondingly receive different types of first conductive terminals are different; so that any type of first terminal module is interchangeable to be mounted into any one receiving cavity.

As can been seen from the above technical solutions, advantages and beneficial effects of the first connector assembly provided by the present disclosure lies in that: the first connector assembly provided by the present disclosure comprises a main outer housing, at least two different types of first terminal modules provided in the main outer housing and at least one independent secondary locking member; the main outer housing is provided therein with at least two receiving cavities, each receiving cavity extends along an up-down direction, and the receiving cavities can allow any type of first terminal module to be interchangeable to insert therein; an inner wall of each receiving cavity of the main outer housing is provided thereon with at least one elastic latching arm which extends along the up-down direction, each first terminal module comprises a first module housing and multiple first conductive terminals mounted in the first module housing, an outer wall of the first module housing is provided thereon with at least one second locking structure, the second locking structure is capable of cooperating with the first locking structure to lock the first module housing to the main outer housing; the independent secondary locking member partially passes through holes of a wall of the main outer housing to insert into the receiving cavities, so that the first terminal modules are locked to the main outer housing. By the above design, all the receiving cavities of the main outer housing of the present disclosure may allow any type of first terminal module to be interchangeable to insert therein, thereby realizing that different types of first terminal modules may be freely and arbitrarily combined and collocated, allowing the user to autonomously select and apply, so that the main outer housing has flexibility in manufacturing, and mold cost and guiding time of the main outer housing may be lowered. Moreover, the present disclosure employs the cooperating design of the first locking structure and the second locking structure, the first terminal module may be more conveniently pushed into the receiving cavity and cooperate with the first locking structure, so that the first terminal module is fixed to the main outer housing. In addition, the present disclosure employs the design of the independent secondary locking member, the first terminal modules can be more securely locked to the main outer housing.

Another main object of the present disclosure is to provide a connector system which comprises the above first connector assembly in order to overcome at least one deficiency of the above prior art.

In order to attain the above object, the present disclosure employs the following technical solutions.

According to one aspect of the present disclosure, the present disclosure provides a connector system, which comprises the first connector assembly provided by the present disclosure and described in the above embodiment and a second connector assembly mating with the first connector assembly.

According to one of embodiments of the present disclosure, the second connector assembly comprises an insulative housing, a plurality of second terminal modules which are provided in the insulative housing, a lever actuator which is mounted on the insulative housing, and two engaging gears which are engaged with the lever actuator; the lever actuator is used to be connected with or separated from the first connector assembly; the lever actuator comprises a lever, the lever is pivotally provided to the second connector assembly, two ends of the lever are respectively provided with driving gears; each driving gear has first gear teeth and a first cam protruding portion; the engaging gear comprises second gear teeth and a second cam protruding portion; the first gear teeth are engaged with the second gear teeth; the inner wall of the first connector assembly is provided with cam grooves, the cam groove is configured to engage with the first cam protruding portion and the second cam protruding portion so that movement of the lever causes the driving gear to pivot the first cam protruding portion and the second cam protruding portion to engage with the cam groove, so that the first connector assembly and the second connector assembly are moved to a position where the first connector assembly and the second connector assembly mate with each other completely, hence the first terminal modules and the second terminal modules which correspondingly engage with each other are electrically connected together.

As can been seen from the above technical solutions, advantages and beneficial effects of the connector system provided by the present disclosure lies in that: the first connector assembly provided by the present disclosure can realize that different types of first terminal modules may be freely and arbitrarily combined and collocated, allow the user to autonomously select and apply, so that the main outer housing has flexibility in manufacturing, and mold cost may be lowered. By operating the lever actuator on the second connector assembly to bring the engaging gears, the first connector assembly and the second connector assembly may more conveniently mate with each other.

### BRIEF DESCRIPTION OF THE DRAWINGS

Various objects, features and advantages of the present disclosure will become more apparent from consideration of the following detailed description of preferred embodiments of the present disclosure in conjunction with the accompanying drawings. The drawings are merely exemplary illustrations of the present disclosure and are not necessarily drawn to scale. Throughout the drawings, the same reference numerals always indicate the same or similar elements, in the drawings:

FIG. 1 is perspective structure schematic view of a first connector assembly according to an exemplary embodiment;

FIG. 2 is an exploded perspective schematic view of the first connector assembly of FIG. 1;

FIG. 3 is a front view of the first connector assembly of FIG. 1;

FIG. 4 is a cross-sectional view taken along a line A-A of FIG. 3;

FIG. 5 is an enlarged schematic view of a B part of FIG. 4;

FIG. 6 is a top view of the first connector assembly of FIG. 1;

FIG. 7 is a cross-sectional view taken along a line C-C of FIG. 6;

FIG. 8 is an enlarged schematic view of a D part of FIG. 7;

FIG. 9 is a cross-sectional view taken along a line E-E of FIG. 6;

FIG. 10 is an enlarged schematic view of first module housings of first terminal modules of FIG. 2;

FIG. 11 is an enlarged schematic view of an F part of FIG. 1;

FIG. 12 and FIG. 13 respectively are enlarged schematic views of two independent secondary locking members;

FIG. 14 is a perspective structure schematic view of a connector system according to an exemplary embodiment;

FIG. 15 is an exploded perspective schematic view of the connector system of FIG. 14;

FIG. 16 is an exploded perspective schematic view of a second connector assembly of the connector system of FIG. 14; and

FIG. 17 is an enlarged schematic view of a G part of FIG. 15.

Reference numerals are presented as follows.
100 first connector assembly
110 main outer housing
1101 receiving cavity
111 elastic latching arm
1111 second guiding surface
1112 second latching surface
1114 latching step
112 through hole
113 opening
114 second latching structure
115 fourth latching structure
1151 latching groove
11511 fourth guiding surface
11512 fourth latching surface
116 cam groove
1161 projection
120 first terminal module
121 first module housing
1211 latching hook
12111 first guiding surface
12112 first latching surface
1212 latching hole
122 first conductive terminal
130 independent secondary locking member
131 latching board
132 latching arm
133 jaw
1321 latching protrusion
140 terminal stabilizer
141 first latching structure
142 third latching structure
1421 latch arm
14211 third guiding surface
14212 third latching surface
200 second connector assembly
210 insulative housing
211 pivoting shaft
2111 protruding part
220 second terminal module
221 second module housing
222 second conductive terminal
230 lever actuator
231 driving gear
2311 first gear tooth
2312 first cam protruding portion
2313 recessed groove
2314 recessed portion
240 engaging gear
2401 second gear tooth
2402 second cam protruding portion
2403 recessed portion
X first direction
Y second direction

### DETAILED DESCRIPTION

Typical embodiments that embody features and advantages of the present disclosure will be described in detail in the following description. It should be understood that the present disclosure can have various changes in different embodiments, these changes does not depart from the scope of the present disclosure, and the description and drawings thereof are essentially used for description and are not used to limit the present disclosure.

In the following description of various exemplary embodiments of the present disclosure, reference is made to the accompanying drawings, the accompanying drawings forms a part of the present disclosure, and the accompanying drawings illustrates various exemplary structures, systems and steps which may realize a plurality of aspects of the present disclosure by way of example. It is to be understood that, other specific arrangements of elements, structures, exemplary devices, systems and steps may be utilized, and structural and function may be modified without departing from the scope of the present disclosure. Furthermore, although the present specification may use the terms “above”, “between”, “within” and the like to describe various exemplary features and elements of the present disclosure, these terms are used herein for convenience only, for example are based on orientation of the example shown in the figures. Nothing in the present specification should be construed as requiring a specific three-dimensional orientation of a structure to fall within the scope of this disclosure.

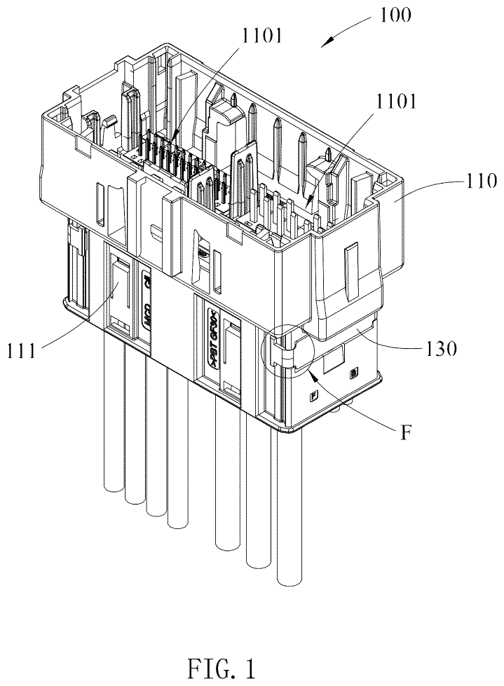

Referring to FIG. 1, FIG. 1 representatively illustrates a perspective structure schematic view of a first connector assembly 100 provided by the present disclosure. In the exemplary embodiment, the first connector assembly 100 provided by the present disclosure is described by taking as example applied to a receptacle connector and a blade-type plug connector. The person skilled in the art easily understands that, in order to apply the relevant design of the present disclosure to other types of connectors, modification, addition, substitution, deletion or other variation will be made to the following specific embodiment, these are still included in the scope of the principle of the first connector assembly 100 provided by the present disclosure.

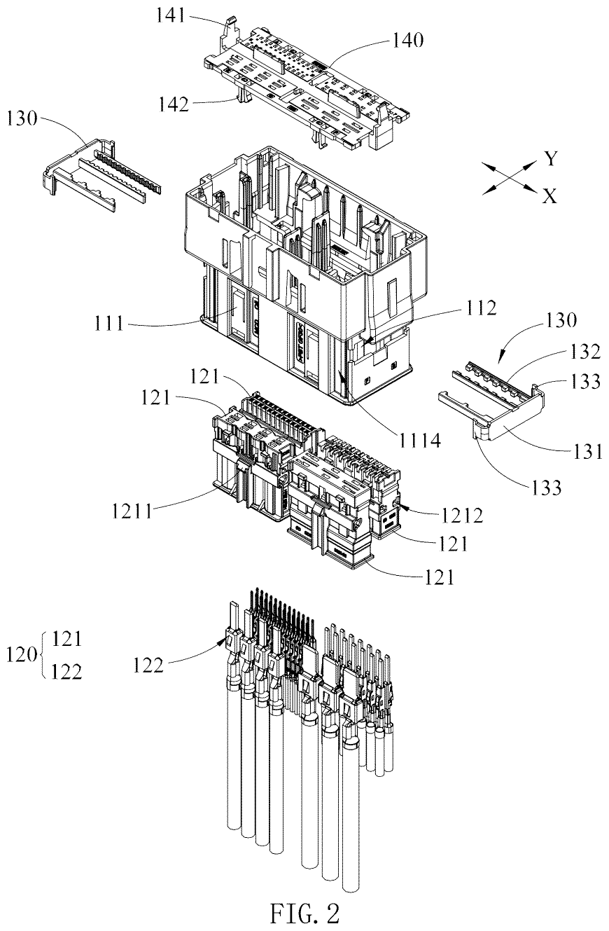

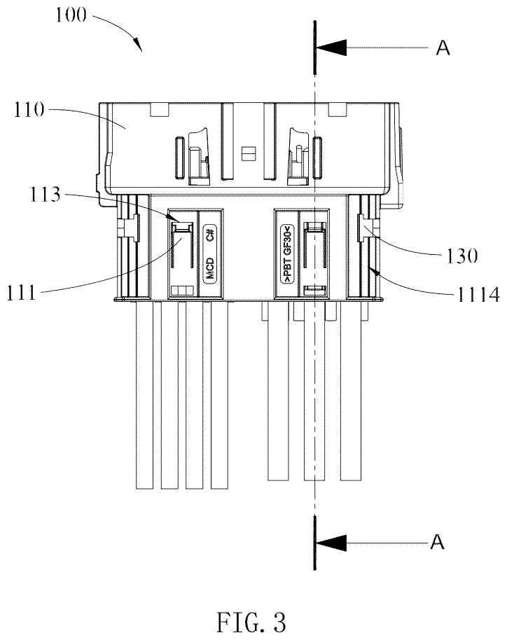

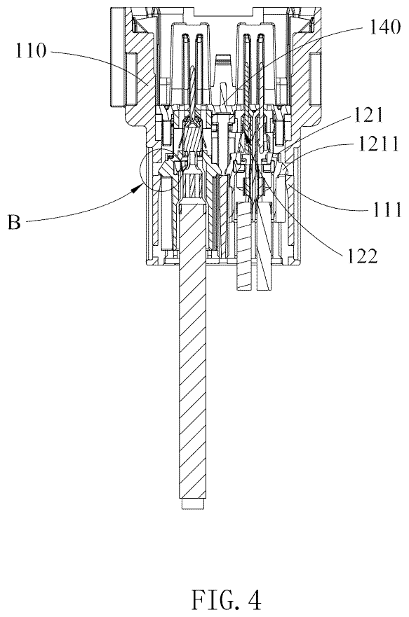

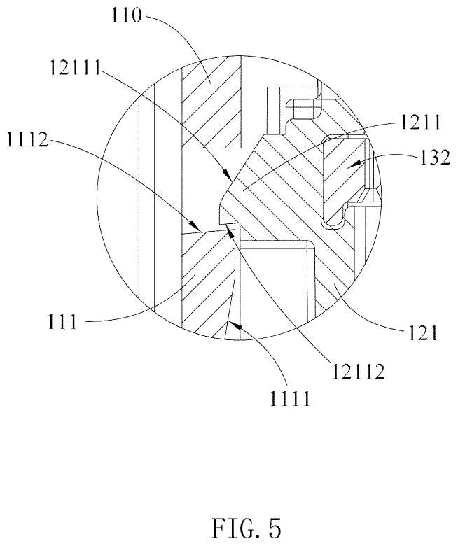

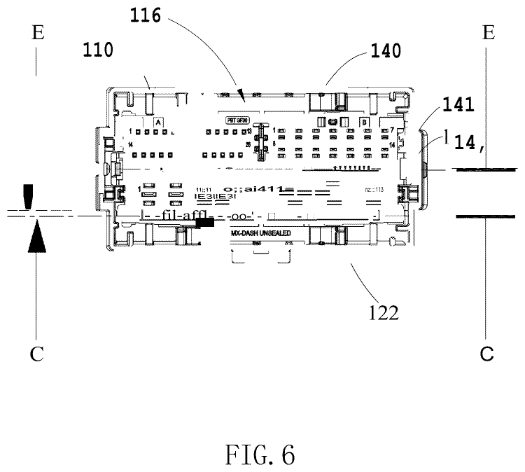

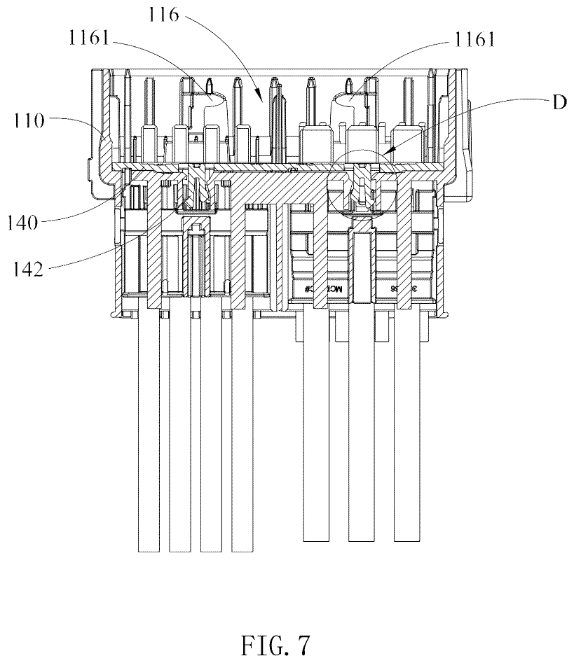

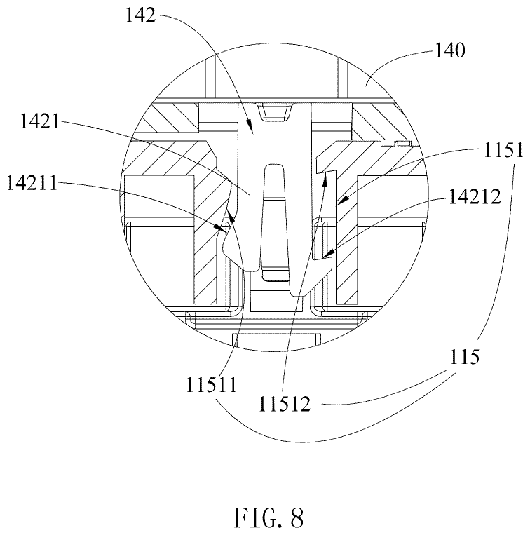

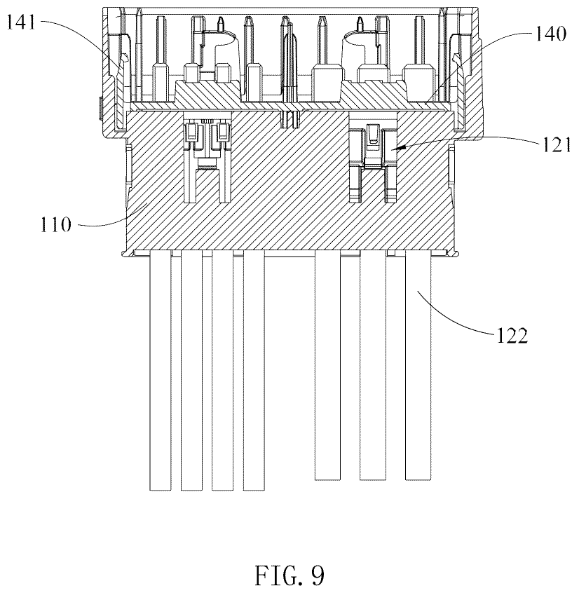

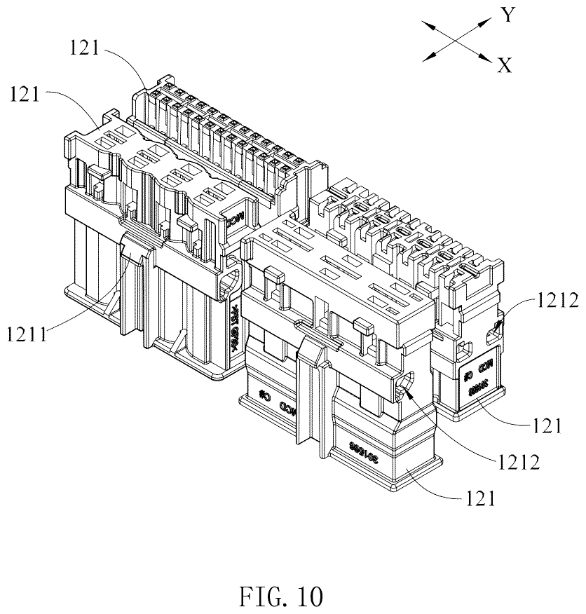

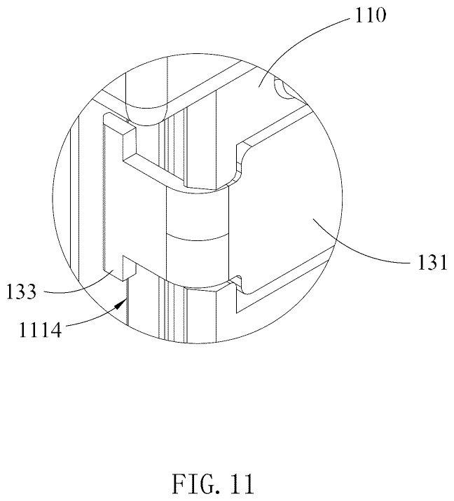

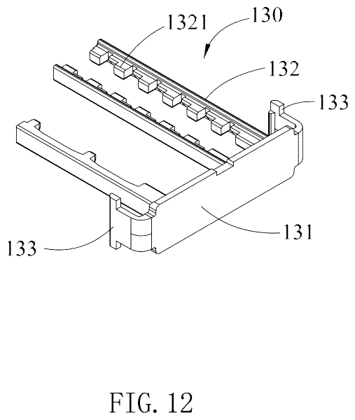

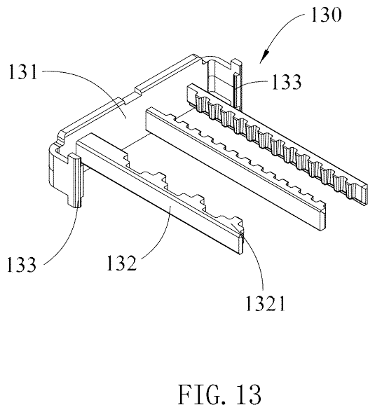

As shown in FIG. 1, in an embodiment of the present disclosure, a first connector assembly 100 provided by the present disclosure includes a main outer housing 110, at least two different types of first terminal modules 120 provided in the main outer housing 110 and at least one independent secondary locking member 130. In conjunction with reference to FIG. 2 to FIG. 13, FIG. 2 representatively illustrates an exploded perspective schematic view of the first connector assembly 100, FIG. 3 representatively illustrates a front view of the first connector assembly 100, FIG. 4 representatively illustrates a cross-sectional view taken along a line A-A of FIG. 3, FIG. 5 representatively illustrates an enlarged schematic view of a B part of FIG. 4, FIG. 6 representatively illustrates a top view of the first connector assembly 100, FIG. 7 representatively illustrates a cross-sectional view taken along a line C-C of FIG. 6, FIG. 8 representatively illustrates an enlarged schematic view of a D part of FIG. 7, FIG. 9 representatively illustrates a cross-sectional view taken along a line E-E of FIG. 6, FIG. 10 representatively illustrates an enlarged schematic view of first module housings 121, FIG. 11 representatively illustrates an enlarged schematic view of an F part of FIG. 1, FIG. 12 and FIG. 13 representatively illustrate enlarged schematic view of two independent secondary locking members 130 respectively. Hereinafter in conjunction with the above figures, structure, connecting manner and function relationship of each main component of the first connector assembly 100 provided by the present disclosure will be described in detail.

As shown in FIG. 1 to FIG. 5, in an embodiment of the present disclosure, the main outer housing 110 is provided therein with four (at least two) receiving cavities 1101, each receiving cavity 1101 extends along an up-down direction, dimensions (for example lengths, widths and heights of the four receiving cavities 1101) and shapes of openings of the four receiving cavities 1101 are substantially consistent, the at least two receiving cavities 1101 are capable of allowing any type of first terminal module 120 to be interchangeable to insert therein. An inner wall of each receiving cavity 1101 of the main outer housing 110 is provided thereon with at least one first locking structure, specifically in the present embodiment, the first locking structure is an elastic latching arm 111 which extends along the up-down direction. Each first terminal module 120 includes a first module housing 121 and multiple first conductive terminals 122 mounted in the first module housing 121, a cable is further connected to below each conductive terminal 122. FIG. 2 and FIG. 10 specifically illustrate four different types of first terminal modules 120, a dimension (a length, a width and a height) and a shape of an outer contour of each first module housing 121 are substantially consistent, but a cavity in an interior of each first module housing 121 used to correspondingly receive the different type of first conductive terminal 122 is different, so that the first module housings 121 may be interchangeable to be mounted into any one receiving cavity 1101. An outer wall of the first module housing 121 is provided thereon with at least one second locking structure, the second locking structure is capable of cooperating with the elastic latching arm 111 to lock the first module housing 121 to the main outer housing 110. A wall of the main outer housing 110 is provided with through holes 112, the independent secondary locking member 130 partially passes through the through holes 112 to insert into the receiving cavities 1101, so as to lock the first terminal modules 120 (for example the first module housings 121 and the first conductive terminals 122) to the main outer housing 110. By the above design, the main outer housing 110 of the present disclosure employs the basically same receiving cavities 1101 to allow any type of the first terminal module 120 to be interchangeable to insert therein, thereby realizing that the main outer housing 110 allows different types of first terminal modules 120 to be freely and arbitrarily assembled, and allows a user to autonomously select and apply, so that the main outer housing 110 has flexibility in manufacturing and may lower mold cost. Specifically, the flexible design of the present disclosure may be specifically embodied as modularized design of the receiving cavities 1101 of the main outer housing 110 and the first terminal modules 120, the different types of first terminal modules 120 may be freely rotated and arbitrarily collocated according to requirement of the user, and then the first terminal modules 120, the main outer housing 110, the independent secondary locking member 130 and a MBS terminal stabilizer 140 are assembled as an integral to offer the user. The main outer housing 110 of the present disclosure only employs one material number, molding tool changing time can be significantly reduced in a molding process. Moreover, the present disclosure employs the cooperating design of the first locking structure and the second locking structure, the first terminal module 120 may be more conveniently pushed into the receiving cavity 1101 and cooperate with the elastic latching arm 111, so that the first terminal module 120 is fixed to the main outer housing 110. In addition, the present disclosure employs the design of the independent secondary locking member 130, the first terminal modules 120 can be more securely locked to the main outer housing 110.

In an embodiment of the present disclosure, a material of the main outer housing 110 may be a plastic.

As shown in FIG. 1 to FIG. 5, in an embodiment of the present disclosure, the first locking structure is the elastic latching arm 111 which extends along the up-down direction, the second locking structure includes a latching hook 1211 which protrudes outwardly from an outer side surface of the first module housing 121, an upper side and a lower side of the latching hook 1211 are respectively provided with a first guiding surface 12111 and a first latching surface 12112. By the above design, the present disclosure makes that the first terminal module 120 may be easily inserted into the main outer housing 110, but cooperation between the first locking structure and the second locking structure of the first terminal module 120 can provide very large pulling resistance which prevents the first terminal module 120 from being accidentally withdrawn in the application of the user. For example, it can be seen from the result of the finite element analysis, the first terminal module 120 can resist an external force of 400N and is not damaged, which ensures stability and reliability of the product under wrong operation of the user.

As shown in FIG. 5, in an embodiment of the present disclosure, the latching hook 1211 may be in form of shark fin. It is noted that, structural forms of the first locking structure and the second locking structure may be diverse, for example are modified as cooperation between an elastic latching hook and a latching hole, in addition, in other embodiment not shown, also are that the latching hook may be modified to be provided to the inner wall of the main outer housing 110, but the elastic latching arm 111 is modified to be provided to the outer side surface of the first module housing 121, that is, a position of the first locking structure and a position of the second locking structure may be interchanged.

As shown in FIG. 2 to FIG. 5, in an embodiment of the present disclosure, the wall of the main outer housing 110 may be further provided with openings 113, one end of the elastic latching arm 111 is integrally connected to one side of the opening 113. A tip of the elastic latching arm 111 is provided with a second guiding surface 1111 and a second latching surface 1112. When the main outer housing 110 and the first terminal module 120 are assembled along the up-down direction, the first guiding surface 12111 of the latching hook 1211 slides over the second guiding surface 1111 of the elastic latching arm 111, and then the first latching surface 12112 of the latching hook 1211 abuts against the second latching surface 1112 of the elastic latching arm 111, so that the first terminal module 120 is locked to the main outer housing 110. By the above design, the wall of the main outer housing 110 of the present disclosure employs integral molding, which does not need to additionally arrange and connect other latching structures on the main outer housing 110 and is beneficial to lower structural complexity.

As shown in FIG. 1, FIG. 2 and FIG. 10 to FIG. 13, in an embodiment of the present disclosure, the independent secondary locking member 130 includes a latching board 131, three latching arms 132 which are connected to a side of the latching board 131, and two jaws 133 which bend from two side edges of the latching board 131 and extend along the same direction as the latching arms 132, the latching board 131 is provided to an outer side of the main outer housing 110 and latches with the main outer housing 110, the latching arms 132 pass through the through holes 112 to insert into the receiving cavities 1101. The latching arm 132 is provided with multiple latching protrusions 1321, the outer wall of the first module housing 121 is provided thereon with a latching hole (latching holes) 1212, the latching arm 132 correspondingly inserts into the latching hole 1212, and has a pre-locking state which permits the first conductive terminals 122 to move up and down and a locking state which is used to lock the first conductive terminals 122 according to different depths which the latching arm 132 inserts into the latching hole 1212, each first conductive terminal 122 also is provided with a recess at a position corresponding to the latching hole 1212, so that the recess may allow the latching protrusion 1321 of the latching arm 132 to insert therein in the locking state, which prevents the first conductive terminal 122 from being downwardly withdrawn the first module housing 121. The wall of the main outer housing 110 is provided thereon with latching steps 1114, the jaws 133 can engage with the latching steps 1114, so that the independent secondary locking member 130 is retained in the pre-locking state or the locking state. The present disclosure can cooperate with the independent secondary locking member 130 selected according to the different types of first terminal modules 120, the first terminal modules 120 and each first conductive terminal 122 are securely locked to the main outer housing 110. Wherein, cooperating with the different types of first terminal modules 120, by selecting a different model of independent secondary locking member 130 (selecting the different model of independent secondary locking member 130 according to a type of the latching protrusion 1321 of the latching arm 132), the present disclosure may very well match the different types of first terminal modules 120, so that flexible design of the product is assured, the user may complete lock releasing function of secondary locking of the terminals without a special tool, which ensures the user operation to be simplified. It is noted that, although the independent secondary locking member 130 of the present disclosure is designed to lock the first module housing 121 and the first conductive terminals 122 to the main outer housing 110 at the same time, in other embodiments not shown, the latching arms 132 of the independent secondary locking member 130 may not be provided with the latching protrusions 1321, that is, are only used to lock the first module housing 121 to the main outer housing 110, whereas the first conductive terminals 122 may be locked to the first module housing 121 by means of terminal locking structures which are provided on the first module housing 121.

As shown in FIG. 2, in an embodiment of the present disclosure, the first locking structure and the independent secondary locking member 130 may be respectively positioned to different sides of the main outer housing 110, the latching arm 132 of the independent secondary locking member 130 extends to an inner side of the second locking structure, so as to prevent cooperation between the first locking structure and the second locking structure from being released. By the above design, the present disclosure can make the main outer housing 110 conveniently leave sufficient arrangement spaces for the elastic latching arms 111 and the independent secondary locking member 130 respectively and avoid the elastic latching arms 111 and the independent secondary locking member 130 interfering with each other in structure or assembling. As shown in FIG. 5, the latching arm 132 of the independent secondary locking member 130 extends to an inner side of the latching hook 1211 (the first locking structure) to support the latching hook 1211, so that locking between the latching hook 1211 and the elastic latching arm 111 is further enhanced, which prevents cooperation between the latching hook 1211 and the elastic latching arm 111 from being released.

As shown in FIG. 1 and FIG. 2, in an embodiment of the present disclosure, a cross section of the first module housing 121 and a cross section of the main outer housing 110 each may be substantially a rectangle, and two adjacent edges of the rectangle define a first direction X and a second direction Y. On this basis, the latching board 131 of the independent secondary locking member 130 extends along the second direction Y, and may correspondingly mounted to a side of the main outer housing 110 along the first direction X, that is, the latching board 131 is mounted on a side surface of corresponding long sides of the main outer housing 110, the latching arms 132 extend along the first direction X, the latching hole 1212 may be provided to the outer wall of the first module housing 121 perpendicular to the first direction X.

As shown in FIG. 2 and FIG. 10, in an embodiment of the present disclosure, the two first terminal modules 120 may be arranged along the first direction X. The first connector assembly 100 may include the two independent secondary locking members 130, the two independent secondary locking members 130 are respectively provided to two opposite sides of the main outer housing 110 in the first direction X, each independent secondary locking member 130 further includes two jaws 133 which bend from two side edges of the latching board 131 and extend along the same direction as the latching arm 132, the main outer housing 110 is provided thereon with the latching steps 1114, the two jaws 133 can engage with the latching steps 1114, so that the independent secondary locking member 130 is retained in the pre-locking state or the locking state.

Further, when the above rectangle is oblong, because the first direction X is a long side direction of the rectangle, if one independent secondary locking member 130 is used to lock the two first terminal modules 120 arranged along the first direction X at the same time, a length of the independent secondary locking member 130 in the first direction X may be too long, which affects structure strength and locking effect of the independent secondary locking member 130, and increases assembling difficulty. By the above design, the present disclosure employs the two independent secondary locking members 130 to respectively lock the two first terminal modules 120 arranged along the first direction X, the structure strength and the locking effect of the independent secondary locking member 130 can be assured, and it is beneficial to lower assembling difficulty.

As shown in FIG. 2, FIG. 10, FIG. 12 and FIG. 13, in an embodiment of the present disclosure, the first terminal modules 120 may be arranged as two groups which are arranged along the first direction X, and each group includes at least two first terminal modules 120 which are arranged along the second direction Y. On this basis, the two independent secondary locking members 130 respectively latch with the two groups of first terminal modules 120. Specifically, the latching board 131 may be provided with at least two latching arms 132, the at least two latching arms 132 respectively latch with the at least two first terminal modules 120 of the same group. For example, FIG. 12 and FIG. 13 illustrate the two independent secondary locking members 130, the latching board 131 of the independent secondary locking member 130 is respectively connected with the three latching arms 132, wherein, the two latching arms 132 of the three latching arms 132 are respectively positioned to two sides of one first terminal module 120 in the second direction Y, and latch with the two sides of the one first terminal module 120 at the same time, the other latching arm 132 of the three latching arms 132 is positioned to one side of the other first terminal module 120 of the same group in the second direction Y, and latches with the one side of the other first terminal module 120. By the above design, the present disclosure employs one independent secondary locking member 130 to realize locking the multiple first terminal modules 120 at the same time, and avoids the length of the independent secondary locking member 130 in the first direction X being too big, which is beneficial to reduce the number of the components, at the same time takes account of structure strength and assembling difficulty.

As shown in FIG. 2, FIG. 6 to FIG. 8, in an embodiment of the present disclosure, the first connector assembly 100 provided by the present disclosure may further include a terminal stabilizer 140, the terminal stabilizer 140 is provided in the main outer housing 110, the terminal stabilizer 140 latches with the main outer housing 110 in a manner that the terminal stabilizer 140 could be movable up and down. The terminal stabilizer 140 can retain positions of the first terminal modules 120 in the main outer housing 110, the terminal stabilizer 140 is provided with several holes which allow mating pins of the first conductive terminals 122 to correspondingly pass therethrough. By the above design, the present disclosure employs the terminal stabilizer 140 to ensure all the first conductive terminals 122 to have better true position, and can take account of application of all the types of terminals, protect pointed ends of mating pins (pins), avoid pin bend, ensure there is no problem of pin stabbing when the user makes a male end and a female end cooperate with each other.

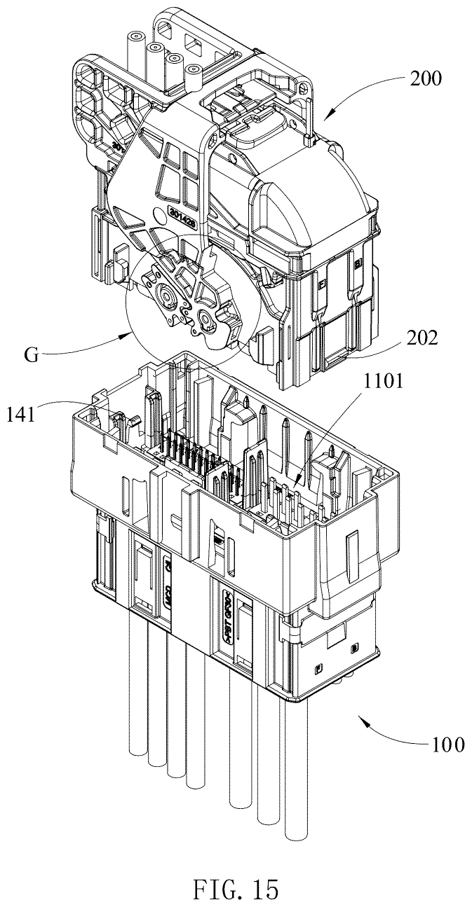

As shown in FIG. 2, FIG. 6, FIG. 7 and FIG. 9, in an embodiment of the present disclosure, side edges of the terminal stabilizer 140 (for example side edges of the terminal stabilizer 140 extend along the first direction X, that is, long sides of the terminal stabilizer 140) are provided with first latching structures 141. The first latching structures 141 preferably are hooks which extend upwardly from two sides of the terminal stabilizer 140, the first latching structures 141 may correspondingly cooperate with latch protrusions 202 on two sides of a second connector assembly 200 (as shown in FIG. 15), so that the second connector assembly 200 may bring the terminal stabilizer 140 to slide upwardly when the second connector assembly 200 is pull out.

As shown in FIG. 8, in an embodiment of the present disclosure, a side surface of the terminal stabilizer 140 which faces the first terminal modules 120 may be provided with third latching structures 142, the inner walls of the receiving cavities 1101 may be provided with fourth latching structures 115, the third latching structure 142 and the fourth latching structure 115 cooperate with each other to limit the highest position that the terminal stabilizer 140 slides upwardly. By the above design, the present disclosure can employ latching and cooperating between the third latching structures 142 and the fourth latching structures 115 to realize to limit sliding up and down of the terminal stabilizer 140 against the main outer housing 110 in position.

As shown in FIG. 8, in an embodiment of the present disclosure, the third latching structure 142 may include two latch arms 1421 which are provided with a gap therebetween, two opposite sides of the two latch arms 1421 are respectively provided with a third guiding surface 14211 which extends gradually, outwardly and obliquely from up to down and a third latching surface 14212 which nearly extends horizontally. And, the fourth latching structure 115 of the main outer housing 110 may include a latching groove 1151, two side groove walls of the latching groove 1151 which face each other are respectively provided with a fourth guiding surface 11511 which extends gradually, outwardly and obliquely from up to down and a fourth latching surface 11512 which nearly extends horizontally. Accordingly, when the main outer housing 110 and the terminal stabilizer 140 are assembled along the up-down direction, the third guiding surface 14211 of the third latching structure 142 slides over the fourth guiding surface 11511 of the fourth latching structure 115, and the third latching surface 14212 of the third latching structure 142 abuts against the fourth latching surface 11512 of the fourth latching structure 115 to prevent the terminal stabilizer 140 from being upwardly removed from the main outer housing 110.

In an embodiment of the present disclosure, dimensions and shapes of openings of the at least two receiving cavities 1101 are substantially consistent. Moreover, dimensions and shapes of outer contours of at least two first module housings 121 also are substantially consistent, but cavities in interiors of the at least two first module housings 121 which are used to correspondingly receive different types of first conductive terminals are different. So-called “substantially consistent” may be understood as completely consistent, or approximately consistent. For example, for the openings of the at least two receiving cavities 1101, dimensions of the openings of the at least two receiving cavities 1101 may be completely consistent, and shapes of the openings of the at least two receiving cavities 1101 may be completely consistent. For example, shapes of the openings of the at least two receiving cavities 1101 are completely consistent, dimensions of the openings of the at least two receiving cavities 1101 are approximate (for example a difference between areas of the openings is within 20%). For example, shapes of the openings of the at least two receiving cavities 1101 are approximate (for example, the openings of the at least two receiving cavities 1101 are substantially rectangle, wherein, corners of the opening of one receiving cavity 1101 corresponding to the rectangle each are a right angle, corners of the opening of the other the receiving cavity 1101 corresponding to the rectangle each are an arc angle). Moreover, so-called “substantially consistent” for the dimensions and the shapes of the outer contours of the at least two first module housings 121 also may be understood with reference to the above explanation. On this basis, any type of first terminal module may be interchangeable to be mounted into anyone receiving cavity.

In conclusion, the first connector assembly 100 provided by the present disclosure includes a main outer housing 110, at least two different types of first terminal modules 120 provided in the main outer housing 110 and at least one independent secondary locking member 130; the main outer housing 110 is provided therein with at least two receiving cavities 1101, each receiving cavity 1101 extends along an up-down direction, dimensions and shapes of the at least two receiving cavities 1101 are consistent, and the receiving cavities 1101 can allow any type of first terminal module 120 to be interchangeable to insert therein; an inner wall of each receiving cavity 1101 of the main outer housing 110 is provided thereon with at least one elastic latching arm 111 which extends along the up-down direction, each first terminal module 120 includes a first module housing 121 and multiple first conductive terminals 122 mounted in the first module housing 121, an outer wall of the first module housing 121 is provided thereon with at least one second locking structure, the second locking structure is capable of cooperating with the first locking structure to lock the first module housing 121 to the main outer housing 110; the independent secondary locking member 130 partially passes through holes 112 of a wall of the main outer housing 110 to insert into the receiving cavities 1101, so that the first terminal modules 120 are locked to the main outer housing 110. By the above design, all the receiving cavities 1101 of the main outer housing 110 of the present disclosure may allow any type of first terminal module 120 to be interchangeable to insert therein, thereby realizing that different types of first terminal modules 120 may be freely and arbitrarily combined and collocated, allowing the user to autonomously select and apply, so that the main outer housing 110 has flexibility in manufacturing, and mold cost and guiding time of the main outer housing 110 may be lowered. Moreover, the present disclosure employs the cooperating design of the first locking structure and the second locking structure, the first terminal module 120 may be more conveniently pushed into the receiving cavity 1101 and cooperate with the first locking structure, so that the first terminal module 120 is fixed to the main outer housing 110. In addition, the present disclosure employs the design of the independent secondary locking member 130, the first terminal modules 120 can be more securely locked to the main outer housing 110.

Based on the above detailed description on the first connector assembly 100 provided by the present disclosure, hereinafter an exemplary embodiment of a connector system provided by the present disclosure is described.

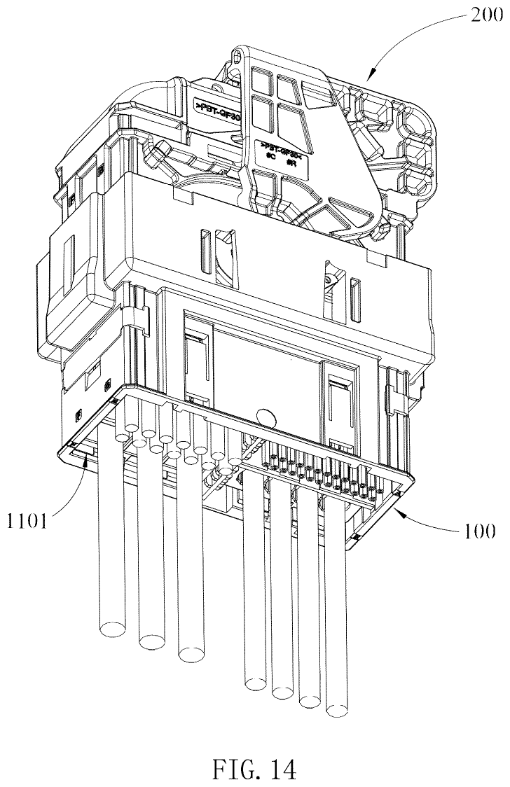

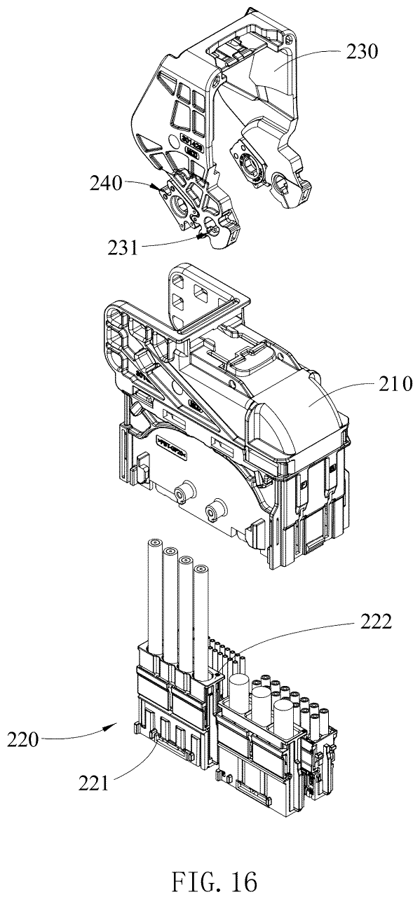

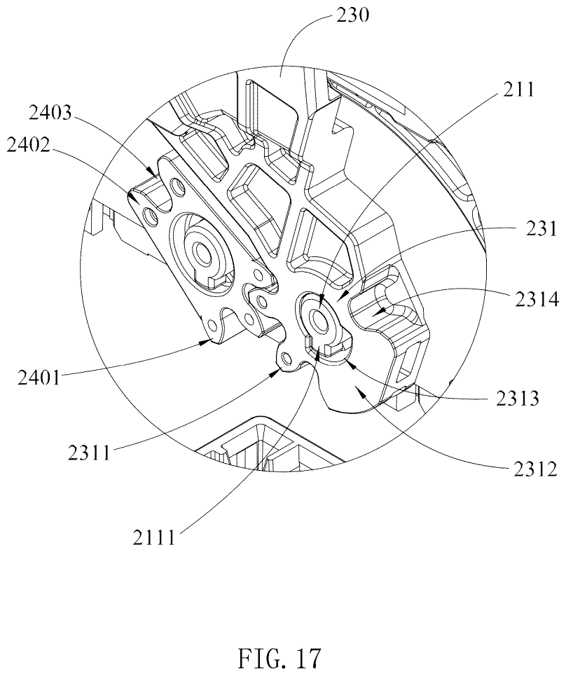

As shown in FIG. 14, in an embodiment of the present disclosure, a connector system provided by the present disclosure includes the first connector assembly 100 which is provided by the present disclosure and is described in detail in the above embodiments and the second connector assembly 200 which mates with the first connector assembly 100. In conjunction with reference to FIG. 15 to FIG. 17, FIG. 15 representatively illustrates an exploded perspective schematic view of the connector system, FIG. 16 representatively illustrates an exploded perspective schematic view of the second connector assembly 200, FIG. 17 representatively illustrates an enlarged schematic view of a G part of FIG. 15. Hereinafter in conjunction with the above figures, structure, connecting manner and function relationship of each main component of a connector system provided by the present disclosure will be described in detail.

As shown in FIG. 14 to FIG. 17, in an embodiment of the present disclosure, the second connector assembly 200 includes an insulative housing 210, a plurality of second terminal modules 220 which are provided in the insulative housing 210, a lever actuator 230 which is mounted on the insulative housing 210, and two engaging gears 240 which are engaged with the lever actuator 230. The second terminal module 220 includes a second module housing 221 and multiple second conductive terminals 222. The lever actuator 230 is used to be connected with or be separated from the first connector assembly 100. The lever actuator 230 includes a lever, the lever is pivotally provided to the second connector assembly 200, and two ends of the lever are respectively provided with driving gears 231. Each driving gear 231 has two first gear teeth 2311 and a first cam protruding portion 2312, pivoting shafts 211 on outer sides of the insulative housing 210 each are provided with a protruding part 2111, the protruding part 2111 cooperates with a recessed groove 2313 on the driving gear 231 to limit the rotation angle of the driving gear 231. The engaging gear 240 includes three second gear teeth 2401 and a second cam protruding portion 2402. The first gear teeth 2311 are engaged with the second gear teeth 2401, the driving gear 231 and the engaging gear 240 are preferably in the same height level. As shown in FIG. 6 and FIG. 7, the inner walls of the first connector assembly 100 are provided with cam grooves 116, two side walls of the cam groove 116 in the first direction X are respectively provided with projections 1161, the two projections 1161 are respectively configured to engage with respective cam protruding portions 2312, 2402, specifically, the engaging gear 240 is formed with a recessed portion 2403 at the second cam protruding portion 2402, the lever actuator 230 is formed with a recessed portion 2314 at the first cam protruding portion 2312, the two recessed portions 2403, 2314 respectively engage with the two projections 1161 provided on the two side walls of the cam groove 116, accordingly the first connector assembly 100 and the second connector assembly 200 are moved to a position where the first connector assembly 100 and the second connector assembly 200 mate with each other completely, so that the first terminal modules 120 and the second terminal modules 220 which correspondingly engage with each other are electrically connected together. A user operates the lever actuator 230 on the second connector assembly 200 to bring the engaging gears 240, the first connector assembly 100 and the second connector assembly 200 may more conveniently mate with each other.

It should be noted that the first connector assembly and the connector system shown in the accompanying drawings and described in this specification are only a few examples among many connector systems that can adopt the principles of the present disclosure. It should be clearly understood that the principles of the present disclosure are not limited to any details or components of the connector system shown in the drawings or described in this specification.

Although the first connector component and the connector system provided by the present disclosure have been described based on different specific embodiments, those skilled in the art will recognize that modifications can be made to the embodiments of the present disclosure within the spirit and scope of the claims.

What is claimed is:

1. A first connector assembly comprising:
a main outer housing having at least two receiving cavities, each receiving cavity extending along an up-down direction, wherein an inner wall of each receiving cavity has a first locking structure, and a wall of the main outer housing being provided with through holes;
at least two different types of first terminal modules, each first terminal module comprising a first module housing and a plurality of conductive terminals mounted therein, wherein an outer wall of each first module housing has a second locking structure which is configured to cooperate with the respective first locking structure to lock the first module housing to the main outer housing; and
at least one independent secondary locking member which is configured to pass through the through holes for insertion into the receiving cavities to lock the first terminal modules to the main outer housing.

2. The first connector assembly according to claim 1, wherein
each first locking structure comprises an elastic latching arm which extends along the up-down direction, and
each second locking structure comprises a latching hook which protrudes outwardly from the first module housing, wherein an upper side and a lower side of the latching hook are respectively provided with a first guiding surface and a first latching surface.

3. The first connector assembly according to claim 2,
wherein the wall of the main outer housing further includes openings and one end of the respective elastic latching arm is integrally connected to one side of the respective opening;
wherein a tip of each elastic latching arm has a second guiding surface and a second latching surface; and
wherein when the main outer housing and the first terminal modules are assembled along the up-down direction, the first guiding surface of the respective latching hook slides over the second guiding surface of the respective elastic latching arm, and then the first latching surface of the respective latching hook abuts against the second latching surface of the respective elastic latching arm, so that the at least two different types of first terminal modules is locked to the main outer housing.

4. The first connector assembly according to claim 1, wherein
the outer wall of each first module housing has a latching hole,
the independent secondary locking member comprises a latching board and a latching arm connected to a side of the latching board, the latching board is positioned on an outer side of the main outer housing and latches with the main outer housing, wherein the latching arm is configured to pass through the through hole to insert into the receiving cavities, wherein the latching arm has multiple latching protrusions which are configured to be inserted into the respective latching holes.

5. The first connector assembly according to claim 4, wherein
dimensions and shapes of openings of the at least two receiving cavities are substantially consistent; and
dimensions and shapes of outer contours of the at least two first module housings are substantially consistent, but cavities in an interior of the at least two first module housings which are used to correspondingly receive different types of conductive terminals are different.

6. A connector system, which comprises the first connector assembly of claim 5 and a second connector assembly configured to mate with the first connector assembly.

7. The first connector assembly according to claim 4, wherein
the first locking structures and the independent secondary locking member are respectively positioned on different sides of the main outer housing, and
the latching arm of the independent secondary locking member extends to an inner side of the second locking structures so as to prevent cooperation between the first locking structures and the second locking structures from being released.

8. The first connector assembly according to claim 7, wherein
dimensions and shapes of openings of the at least two receiving cavities are substantially consistent; and
dimensions and shapes of outer contours of the at least two first module housings are substantially consistent, but cavities in an interior of the at least two first module housings which are used to correspondingly receive different types of conductive terminals are different.

9. A connector system, which comprises the first connector assembly of claim 8 and a second connector assembly configured to mate with the first connector assembly.

10. The first connector assembly according to claim 4, wherein
a cross-section of the first module housing is a rectangle, and two adjacent edges of the rectangle define a first direction and a second direction; and
the latching board is correspondingly mounted to a side of the main outer housing along the first direction, the latching arms extend along the first direction, and the latching hole is positioned on the outer wall of the first module housing perpendicular to the first direction.

11. The first connector assembly according to claim 10,
further comprising a second independent secondary locking member comprising a latching board and a latching arm connected to a side of the latching board, wherein the independent secondary locking members are respectively mounted to two opposite sides of the main outer housing in the first direction, and each independent secondary locking member further comprises two jaws which bend from two side edges of the latching board and extend along the same direction as the latching arms, and
wherein the main outer housing has latching steps to which the two jaws of the respective independent secondary locking member are configured to engage.

12. The first connector assembly according to claim 11,
wherein the first terminal modules are arranged as two groups which are arranged along the first direction, each group comprises at least two first terminal modules which are arranged along the second direction; and
wherein the two independent secondary locking members respectively latch with the two groups of first terminal modules, each latching board is provided with at least two latching arms, the at least two latching arms respectively latch with the at least two first terminal modules of the same group.

13. The first connector assembly according to claim 1,
further comprising a terminal stabilizer configured to be mounted in the main outer housing and to latch with the main outer housing, wherein the terminal stabilizer is movable up and down relative to the main outer housing, and the terminal stabilizer has with several holes which allow the conductive terminals to correspondingly pass therethrough.

14. The first connector assembly according to claim 13,
wherein side edges of the terminal stabilizer have first latching structures comprising hooks which extend upwardly from two sides of the terminal stabilizer, and a side surface of the terminal stabilizer which faces the first terminal modules has third latching structures, and
wherein the inner walls of the receiving cavities have fourth latching structures, the third latching structure and the fourth latching structure cooperate with each other to limit the highest position that the terminal stabilizer slides upwardly.

15. The first connector assembly according to claim 14, wherein
the third latching structure comprises two latch arms having a gap therebetween, two opposite sides of the two latch arms respectively have a third guiding surface which extends gradually, outwardly and obliquely from up to down and a third latching surface which extends horizontally,
the fourth latching structure comprises a latching groove, two side groove walls of the latching groove which face each other respectively have a fourth guiding surface which extends gradually, outwardly and obliquely from up to down and a fourth latching surface which extends horizontally, and
wherein the third latching surface and the fourth latching surface abut against each other to prevent the terminal stabilizer from being upwardly removed from the main outer housing.

16. The first connector assembly according to claim 13, wherein
dimensions and shapes of openings of the at least two receiving cavities are substantially consistent; and
dimensions and shapes of outer contours of the at least two first module housings are substantially consistent, but cavities in an interior of the at least two first module housings which are used to correspondingly receive different types of conductive terminals are different.

17. The first connector assembly according to claim 1, wherein
dimensions and shapes of openings of the at least two receiving cavities are substantially consistent; and
dimensions and shapes of outer contours of the at least two first module housings are substantially consistent, but cavities in an interior of the at least two first module housings which are used to correspondingly receive different types of conductive terminals are different.

18. A connector system, which comprises the first connector assembly of claim 17 and a second connector assembly configured to mate with the first connector assembly.

19. A connector system, which comprises the first connector assembly of claim 1 and a second connector assembly configured to mate with the first connector assembly.

20. The connector system according to claim 19, wherein the second connector assembly comprises:
an insulative housing;
a plurality of second terminal modules seated in the insulative housing;
a lever actuator configured to be connected with or separated from the first connector assembly, the lever actuator comprising a lever pivotally mounted on the insulative housing, driving gears on the lever, each driving gear having first gear teeth and a first cam protruding portion, and engaging gears on the lever, each engaging gear comprises second gear teeth and a second cam protruding portion, wherein the first gear teeth are engaged with the second gear teeth for respective pairs of the driving gears and the engaging gears; and
wherein the inner wall of the first connector assembly is provided with cam grooves configured to engage with the first cam protruding portion and the second cam protruding portion so that movement of the lever causes the driving gears to pivot the first cam protruding portions and the second cam protruding portions to engage with the cam grooves, so that the first connector assembly and the second connector assembly are moved to a position where the first connector assembly and the second connector assembly mate with each other completely and the first terminal modules and the second terminal modules which correspondingly engage with each other are electrically connected together.
